(19) United States
(12) Patent Application Publication
(10) Pub. No.: US 2014/0100879 A1
(43) Pub. Date: Apr. 10, 2014

(54) Systems and Methods for Device and Meter Monitoring

(71) Applicant: Infometers, Inc., Sunnyvale, CA (US)

(72) Inventors: Akhsar Kharebov, Sunnyvale, CA (US); Alan Kharebov, Sunnyvale, CA (US); Alexander Gorelik, Palo Alto, CA (US)

(73) Assignee: Infometers, Inc., Sunnyvale, CA (US)

(21) Appl. No.: 14/047,751

(22) Filed: Oct. 7, 2013

Related U.S. Application Data
(60) Provisional application No. 61/711,141, filed on Oct. 8, 2012.

(51) Int. Cl. G06F 19/00

(52) U.S. Cl. CPC G06F 19/3418
USPC 705/3

(57) ABSTRACT

The invention disclosed herein overcomes obstacles in providing connectivity to personal medical meters and mobile computing devices. Systems, methods, and devices of the invention allow subjects to connect personal medical monitors/meters to the cloud through mobile computing devices. The invention further allows a user or a subject remote access to medical meter data using a mobile computing device on demand.

### CROSS REFERENCE TO RELATED APPLICATIONS

This application claims the benefit of U.S. Provisional Application No. 61/711,141, filed on Oct. 8, 2012, the contents of which is incorporated herein by reference in its entirety.

### BACKGROUND OF THE INVENTION

Successful chronic disease management depends on regular and timely testing, data reporting, data analysis, and adjustment of treatment. However, conventional approaches to health care, such as doctor office visits, lack a proper structure to support remote patient monitoring. This deficiency delays timely delivery of medical data, and adversely affects delivery of chronic disease treatment and, thus, patient outcomes.

Most personal medical devices and meters have evolved to support integration with patients' PCs or hardware connectivity hubs. Mobile computing devices are the most ubiquitous personal computing devices today, and increasingly patients lead a mobile lifestyle. Mobile devices can provide a viable delivery strategy of medical data to a medical provider. However, the current approaches to the integration of patients' remotely-connected medical data lack a scalable, software-driven, support system for mobile computing devices.

Currently, remote patient monitoring is achieved with a plurality of decentralized electronic devices, and costly is the pursuit of connectivity and/or approval from the Food and Drug Administration (FDA) individually for each decentralized existing device.

### SUMMARY OF THE INVENTION

In some embodiments, the invention provides a method of recording data, the method comprising: a) providing communication between a computer system and a medical meter, wherein the computer system comprises a processor; b) retrieving, by the processor, data from the medical meter; and c) recording the retrieved data on an electronic medical record associated with a subject.

In some embodiments, the invention provides a computer program product comprising a computer-readable medium having computer-executable code encoded therein, the computer-executable code adapted to be executed to implement a method for recording data, the method comprising: a) providing a connectivity system, wherein the connectivity system comprises: i) an integration module; ii) a retrieval module; and iii) a recording module; b) integrating by the integration module an application interface in an electronic device, wherein the application interface is compatible with a medical meter; c) retrieving by the retrieval module data from the medical meter via the application interface; and d) recording by the recording module the retrieved data in an electronic medical record.

In some embodiments, the invention provides a method of recording data, the method comprising receiving, by a computer system, data from a medical meter, wherein the computer system comprises a processor, whereupon the processor records at least a portion of the received medical data in an electronic medical record.

In some embodiments, the invention provides a computer program product comprising a computer-readable medium having computer-executable code encoded therein, the computer-executable code adapted to be executed to implement a method supporting an interaction of distinct data layers, the method comprising: a) providing a physical layer interaction system, wherein the physical layer interaction system comprises: i) a control module; ii) a retrieval module; and iii) a transmittal module; b) controlling by the control module the interaction of a first physical layer and a second physical layer, wherein the controlling summarizes at least one computer-executable data package command, thereby providing a congruent interaction between the first physical layer and the second physical layer, wherein the first physical layer is associated with a medical meter; c) retrieving by the retrieval module data from the first physical layer; and d) transmitting by the transmitting module the retrieved data over a network.

### BRIEF DESCRIPTION OF THE FIGURES

FIG. 1 is a block diagram illustrating a first example architecture of mobile computer, medical device, and network system that can be used in connection with example embodiments of the present invention.

FIG. 2 is a diagram illustrating a mobile computer and medical device network configuration that can be used in connection with example embodiments of the present invention.

FIG. 3 is a diagram illustrating a mobile computer and medical device network configuration that can be used in connection with example embodiments of the present invention.

FIG. 4 is a diagram illustrating a mobile computer and medical device network configuration that can be used in connection with example embodiments of the present invention.

FIG. 5 is a block diagram illustrating a first example architecture of a computer system that can be used in connection with example embodiments of the present invention.

FIG. 6 is a diagram illustrating a computer network that can be used in connection with example embodiments of the present invention.

FIG. 7 is a block diagram illustrating a second example architecture of a computer system that can be used in connection with example embodiments of the present invention.

FIG. 8 illustrates a global network where a data record retrieved from a medical meter can be transmitted.

### DETAILED DESCRIPTION

Remote monitoring can provide a physician with real time data on subjects while providing substantial savings in health care costs. Currently, over 2,000 different medical and fitness meters are on the market, along with hundreds of new meters entering and leaving the market every year, which can potentially provide a physician with valuable patient metrics. Nevertheless, providing connectivity to such meters, and transmitting the data to health professionals in facilities such as monitoring centers, private offices, hospitals, among others, is a non-trivial technical challenge.

Existing remote patient monitoring technologies have focused on developing online platforms for patient communication with a health care provider, developing online platforms for the online storage of medical data, sensor systems for detecting emergency situations, and development of individual specialized medical meters capable of transmitting medical data. Such technologies rely on isolated and decentralized efforts to support remote patient monitoring, are typically tailored to a single medical condition, and fail to provide a large scale technological development that supports remote monitoring from a plurality of existing medical meters.

A plurality of existing medical meters can collect a wide range of health data points from a subject, such as vital signs, weight, blood pressure, blood sugar, blood oxygen levels, heart rate, and electrocardiograms. The ability to transmit such data timely to health care providers can reduce the cost of health care, provide older and disabled individuals with greater independence, help subjects in rural areas or subjects without easy access to a primary care center provide crucial data to physicians, and ultimately can save lives. However, the development of individual technologies that could provide connectivity to hundreds of individual medical meters to one device at a time is cost-prohibitive and time consuming.

The invention disclosed herein overcomes obstacles preventing data connectivity between a medical meter, an electronic device, and/or a health care provider, by providing a centralized connectivity system to a plurality of devices. The invention provides one easy-to-use connectivity package that communicates with a plurality of existing devices and grants connectivity to the plurality of existing devices. The invention reduces the need for the development effort of connectivity on individual existing devices, thereby supporting the remote subject monitoring of a plurality of subjects.

A system of the invention can collect medical meter data from individuals and electronically transmit the data to health care providers in a different location for assessment and recommendations. By providing connectivity to a plurality of medical meters, the invention provides an aggregated connectivity layer for subject monitoring meters and devices. In some embodiments, the health care provider can record the transmitted data in a medical record associated with a subject. In some embodiments, the connectivity system of the invention can record the transmitted data in a medical record associated with a subject.

The invention can further transmit the data to subjects, subjects' families, caregivers, health care providers, health care facilities, and stakeholders in health care delivery. Access to data in a medical meter can occur, for example, through electronic interfaces that provide direct access to one or a plurality of users. The exceptional accessibility and convenience provided by the invention disclosed herein allows any user to view, evaluate, and adjust information as needed or desired in real time. Overall, the speed and convenience of health information access improves quality of care, quality of life, and subject happiness.

The invention further provides a convenient interface where a subject can upload, download, view, share, distribute, and act on up-to-date test results retrieved from a medical meter or a monitoring device. In some embodiments, a mobile computing device is used by a subject to interact with an interface that provides the subject, or a user, with tools to upload, download, view, share, distribute, and act on up-to-date test results. In some embodiments, software is installed on a mobile computing device, a medical meter, a monitoring device, and/or a server configured to receive information and maintain an online or electronic database of medical device data. In some embodiments, the installed software can provide the subject, or a user, with access to an interface with tools to upload, download, view, share, distribute, and act on up-to-date test results.

Subjects can be, for example, elderly adults, adults, adolescents, pre-adolescents, children, toddlers, or infants. Subjects can be patients being remotely monitored. Users of the system can be, for example, physicians, users affiliated with a remote care facility, custodians of the subject, health care providers, care takers, and family members. In some embodiments, a medical meter monitors a subject.

Furthermore, the invention reduces economic costs of care and improves patient outcomes by allowing the patient to transmit medical meter test results via, for example, a mobile computing device to a medical monitoring system, which can flag adverse patient conditions and provide actionable and life-saving advice to the patient in a remote setting. Non-limiting examples of mobile computing devices include, for example, phones, tablets, personal data assistants, and personal computers.

Non-limiting examples of medical meters or monitoring devices include a blood glucose meter, a blood gas meter, a blood pressure sensor or a cuff, a digital pulse and/or heart monitor, an oxygenation rate monitor, a weight scale, a body composition monitor, a thermometer, a spirometer, an electrocardiogram, a sleep monitor, an ultrasound, a spectrometer, a radiation monitor, and sensors for vital sign and environmental monitoring.

### Systems of the Invention.

The invention overcomes challenges in providing connectivity to a plurality of distinct meters, which differ in, for example, hardware, software, user preferences, and localization. The invention overcomes a challenge presented by the device fragmentation found in the market by, for example, providing a unique connectivity package that is compatible with a plurality of devices.

The invention provides several software components to access and retrieve information from existing medical monitoring devices and meters. The invention further provides a method for providing the information to mobile computing devices and online portals. Non-limiting examples of software components of the invention include: a) a connectivity module; b) a control module; c) a data retrieval module; d) a data processing module; e) an information display module; f) a data transport module; g) a local storage capabilities module; h) a sessions module; i) a presentation module; and j) network storage module. The software components can operate, for example, individually or in combination with other components of the invention. The software components of the invention can operate on active and/or passive hardware networking components that convert or integrate physical, electrical, and/or other communication protocol properties of data exchange to provide fluid and real-time communication between health care devices and communication devices.

A computer program product of the invention is compatible with a variety of hardware architectures, such as a physical layer system. A physical layer system can be used to provide connectivity/communication to a medical meter, a medical monitor, and/or an electronic device. A physical layer system can comprise at least one physical layer. In some embodiments, a physical layer is a product of an abstraction process by which data and computer programs are defined. In some embodiments, the invention interacts with a physical layer system on a medical meter, a medical monitor or a device to provide connectivity to the medical meter, a medical monitor, and/or the device.

The flow of information through a system of the invention is seamless and unencumbered. In some embodiments, the invention provides a computer program product, having computer code encoded therein, the computer-executable code adapted to be executed to implement a method supporting the interaction of distinct data layers. For example, a first data layer interacting with a second data layer can provide a point-to-point transfer of data between components of the first and the second physical layer. In some embodiments, a first data layer interacting with a second data layer can provide a point-to-point layer transfer of data among a plurality of components. Physical interactions within a network can further provide a method to deliver data from a source to a destination. Non-limiting examples of data communication layers include physical layers such as serial ports; point to point protocols such as RS232, and USB; wireless protocols such as BlueTooth 2.0 and 4.0, IEEE 802.11a, b, g and n; data link layers with protocols such as Ethernet; transport and network link layers with protocols such as transmission control protocol/internet protocol (TCP/IP) or user datagram protocol (UDP); as well as session, presentation, application layer protocols and/or another Open Systems Interconnection (OSI) or ISO/ICE 7498-1 model layer and protocol.

A transport layer module can support the interaction among different physical layers of a medical meter and/or a medical monitor. In some embodiments, the transport layer module provides a mechanism of data transfer between mobile computing devices and personal medical or health monitoring devices and meters. Data transfer can be efficient, safe, and transparent. In some embodiments, a sessions layer can establish, manage, and terminate connection of a data exchange. In some embodiments, a presentation layer can translate data representation between application and network formats. In some embodiments, an application layer can manage an interaction between user and interconnection layers managing a data exchange or virtual network system. In some embodiments, a computer interface layer, such as a dashboard, can mediate data transfer. In some embodiments, a computer system of the invention receives by a computer system medical data from a medical meter, wherein the computer system comprises a processor, whereupon the processor records at least a portion of the received medical data in an electronic medical record.

One or a plurality of physical and/or virtual layers of the invention can be combined to provide a connectivity package to a medical monitor or a medical meter. A physical or virtual layer of the invention can be used in combination with other software modules, for example, to download medical monitoring data from medical devices to standard mobile computing devices, or to download data onto an online database. The connectivity system of the invention can further comprise a physical layer. The components of a physical layer of the invention can be integrated or built into mobile computing device or the patient medical meter.

A computer program product of the invention can be provided in the form of a mobile software application and a software development kit (SDK) package. A computer program product of the invention can integrate a plurality of layers, components, modules, and algorithms. In some embodiments, the unique connectivity package of the invention provides a method of recording data, the method comprising providing communication between a computer and a medical meter, wherein the computer system comprises a processor, retrieving, by the processor, data from the medical meter, and recording the retrieved data on a medical record associated with a subject. In some embodiments, the invention provides a method of recording medical data retrieved from a personal medical meter on a medical record.

The invention provides a system that converts or integrates physical, electrical, and/or other communication protocol properties of the data exchange between standard mobile computing devices and personal digital medical or health monitoring devices or meters by a method and device that are components effective for: a) connection establishment; b) control; c) data retrieval; d) data processing; e) data display; f) local storage capabilities; and g) networked storage capabilities. A non-limiting example includes capturing information from a medical device through RS232 protocol, and communicating the information obtained from the device to an application running on a mobile device through an API, to a Health Record System such as Microsoft® HealthVault™ through a REST API over TCP/IP network; or to a medical information management system, such as Epic, through a Web Services call over a TCP/IP network. In addition to translating from one protocol to another, the invention would translate the data coming through a device (for example, a series of blood pressure measurements), into a set of HL7 or LOINC messages that specify patient information, device information and the measurements.

In some embodiments, a virtual or hardware network converts or integrates physical, electrical, and/or other communication protocol properties of multiple medical meters, converter hubs, and/or mobile computing devices. In some embodiments, converter hubs, associated with virtual or physical networks, provide connectivity to multiple medical meters and mobile computing devices. In some embodiments, the invention provides networking components compatible with existing mobile and medical devices to allow data exchange. In some embodiments, the invention provides connectivity by providing a communication protocol. In some embodiments, the configuration of virtual or hardware network components forms a physical layer of a connectivity system of the invention.

In some embodiments, the invention provides a computer program product comprising a computer-readable medium having computer executable code encoded therein, the computer-executable code adapted to be executed to implement a method for recording data, the method comprising: a) providing a connectivity system, wherein the connectivity system comprises: i) an integration module; ii) a retrieval module; and iii) a recording module; b) integrating by the integrating module an application interface in an electronic device, wherein the application interface is compatible with the medical meter; c) retrieving by the retrieval module data from the medical meter; and d) recording by the recording module the retrieved data in a medical record.

In some embodiments, integrating an application interface in an electronic device comprises installing an application on an electronic device and/or installing an application on a medical meter. In some embodiments, integrating an application interface comprises accessing an application on an electronic device and/or installing an application on a medical meter.

In some embodiments, a computer program product of the invention further comprises a reporting module, wherein the reporting module reports the retrieved medical data to a user. In some embodiments, a computer program product of the invention further comprises a recommendation module, wherein the recommendation module provides a recommendation to a user based on the retrieved data.

In some embodiments, the device uses a method that dynamically configures the virtual network systems to integrate disparate and congruent meter and hub communication formats. Non-limiting examples of communication formats that can be used alone or in combination include USB, serial, Bluetooth, WiFi, infrared, ZigBee, Ant+, and/or NFC. In some embodiments, communication is integrated across other OSI layers to deliver the data to a remote server, EHR, EMR or another destination on the network.

In order to integrate disparate and congruent meter and hub communication formats, the device adds abstraction frames around the meter data in order to control the various disparate and congruent components of the system.

In order to translate medical device data into congruent hub messages, the device captures a context of the message such as: patient information; device information; and measurement details. Patient information can be obtained during device configuration. Multiple patients can be supported for a single device, in which case, a patient can be specified at the time of the measurement reading. If a single patient is configured, all measurement readings correspond to that patient.

Device information is obtained from the medical device itself, is specified by the user at device registration and configuration time, and/or is downloaded from a remote server storing device information. Device information can include the type of a device, device manufacturer, model number and units of measure. For example, a scale may provide measurements in pounds or kilograms. This information can be specified once per device or for every measurement.

Measurement information can include the time of measurement, the type of measurement, and the measurement value. A system of the invention can keep track of the time of the last measurement sent to each destination such as the health hub, and/or application, and/or HER and EMR system, and/or another remote or local storage repository and establish a cutoff time corresponding to the last measurement sent to ensure that only previously-non-transmitted measurements are sent. The system also supports requests for measurements for a specific time period including the previously-sent measurements.

In some embodiments, a medical meter and/or a medical monitor can be physically connected to a device directly through a congruent connection, without the use of intermediary hubs. In some embodiments, a plurality of medical meters and/or medical monitors can be physically connected to a device(s) directly through a congruent connection. A congruent connection can be a compatible connection.

In some embodiments, the invention provides a computer program product comprising a computer-readable medium having computer-executable code encoded therein, the computer-executable code adapted to be executed to implement a method supporting the interaction of distinct data layers, the method comprising: a) providing a physical layer interaction system, wherein the physical layer interaction system comprises: i) a control module; ii) a retrieval module; and iii) a transmittal module; b) controlling by the control module the interaction of a first physical layer and a second physical layer, wherein the controlling summarizes at least one computer-executable command, thereby providing a congruent interaction between the first physical layer and the second physical layer; c) retrieving by the retrieval module data from the first physical layer; and d) transmitting by the transmitting module the retrieved data over a network.

In some embodiments, at least one medical meter is connected to a device indirectly through a series of passive and/or active, converter hubs. In some embodiments, at least one medical meter is connected to a device indirectly through a cable and/or a wireless connection. The number of medical meters that can be simultaneously connected to the device directly or indirectly through a series of passive and/or active cable and/or wireless converter hubs can be dependent on the communication properties of medical meters, the network component configuration, or the capabilities of the mobile computing device. In some embodiments, the number of medical meters that can be simultaneously connected to a device is at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, at least 25, at least 26, at least 27, at least 28, at least 29, at least 30, at least 31, at least 32, at least 33, at least 34, at least 35, at least 36, at least 37, at least 38, at least 39, at least 40, at least 41, at least 42, at least 43, at least 44, at least 45, at least 46, at least 47, at least 48, at least 49, or at least 50. In some embodiments, the number of medical meters that can be simultaneously connected to a device ranges from about 1 to about 3, from about 2 to about 5, from about 3 to about 6, from about 4 to about 7, from about to about 8, from about 6 to about 9, from about 10 to about 15, from about 15 to about 20, from about 20 to about 25, from about 25 to about 30, from about 30 to about 35, from about 35 to about 40, from about 40 to about 45, or from about 45 to about 50.

In some embodiments, a computer-program product of the invention establishes and controls a virtual network system configured to control disparate components by processing commands a series of times, each time matching communication protocol of the successive layer in the network. In some embodiments, the processing of disparate components summarizes at least one computer-executable data package.

In some embodiments, the invention provides a system that effectively supports data exchange between mobile computing devices and personal digital medical or health monitoring devices or meters, comprising, for example, components for: a) a connectivity establishment; b) control; c) data retrieval; d) data processing; e) data display; f) local storage capabilities; and g) networked storage capabilities.

In some embodiments, the device creates a virtual network system of otherwise incongruent meters, devices, and hubs. A virtual network system can be dynamic. A virtual network system can be dynamically configured to integrate a series of disparate and congruent meters and hubs. A virtual network system can dynamically harmonize the communication of a series of disparate and congruent meters and hubs. A hub can be a physical gadget providing a mechanism for connecting multiple medical meters and devices.

In some embodiments, at least one medical meter is connected to an electronic device directly through a congruent connection, without the use of intermediary hubs. In some embodiments, at least one medical meter is connected to an electronic device indirectly through a series of passive and/or active, cable and/or wireless converter hubs.

In some embodiments, an electronic device can download, store, or upload medical meter data that was accessed, retrieved, processed, or displayed. Retrieving, accessing, processing or displaying data can be done by a plurality of communication protocols. The communication protocols used in a communication among a medical meter, an electronic device, and/or a converter hub can be identical, similar, or different.

An electronic device can establish and control the operation of a virtual network system configured of disparate components by summarizing commands a series of times, each time identifying a matching communication protocol of a successive layer in the network. In some embodiments, summarizing a command comprises shortening a command.

A system of the invention can implement virtual or physical networking model components on an electronic device. An electronic device can comprise, for example: a data layer, a network layer, a transport layer, a sessions layer, an application layer, and a presentation layer interaction for the virtual or physical network system.

In some embodiments, a system of the invention can process the data retrieved from a medical meter system or a network system on an electronic device receiving data retrieved from the medical meter by parsing the message and extracting the values received. In some embodiments, an electronic device can provide graphical representation of retrieved medical meter data.

A system of the invention can provide online access to data retrieved from a medical meter, and a system of the invention can backup data retrieved from a medical meter, for example, on a cloud, an accessible internet, or an intranet database. A system of the invention can receive data retrieved from a medical meter. In some embodiments, the receiving of the data is wireless. In some embodiments, the receiving of the data is by a wired connection.

A system of the invention can further comprise a server and can create a virtual networking model to work with the components of the system. In some embodiments, a system of the invention can autonomously process steps for: a) connection establishment; b) control; c) data retrieval; d) data processing; e) data display; f) local storage capabilities; and g) networked storage capabilities, for example, by using time intervals defined by a user's chosen medical meter and converter hub communication protocol properties.

In some embodiments, a system of the invention provides a recommendation to a user based on data retrieved from a medical meter. A computer program product, suitable for retrieving data from a medical meter, providing connectivity to a medical meter, and/or providing a physical layer interaction system can comprise: a) a connection establishment module; b) a control module; c) a retrieval module; d) a data processing module; e) a data display module; f) a local storage module; g) a networked storage module; h) a recording module; and i) a transmittal module. In some embodiments, a system of the invention provides a recommendation to a subject. In some embodiments the recommendation is a treatment. In some embodiments, the recommended treatment provides a diet recommendation. In some embodiments, the recommended treatment provides a lifestyle recommendation.

In some embodiments, the recommendation is an instruction for further analysis of the connectivity within the networked system. The system can, for example, provide instructions to a user. A user can, for example, follow a recommendation to fix or improve the connectivity within an electronic device, a medical meter, and a converter hub.

In some embodiments, a system of the invention can be accessed from an electronic device used by a subject or a healthcare provider to download medical meter/monitoring data from a subject's medical device to a standard mobile computing device. In some embodiments, the medical meter monitors the subject. In some embodiments, the subject wears the medical meter. In some embodiments, the subject is monitored remotely. In some embodiments, at least one medical meter is connected to a system of the invention directly through a congruent connection, without the use of intermediary hubs. In some embodiments, at least one medical meter is connected to a system of the invention indirectly through a series of passive and/or active cable and/or wireless converter hubs.

A system of the invention can establish and control the operation of a virtual network system comprising disparate components by encapsulating commands a series of times, each time matching a communication protocol of the successive layer in the network. A non-limiting example is a system comprising of a plurality of medical devices such as glucometers, heart monitors, weight scales and other relevant devices communicating to the system of the invention through a plurality of wired and wireless protocols, and the system of the invention communicating to a variety of applications, health information hubs, and health management systems running on a plurality of computing platforms through a plurality of communication protocols.

In some embodiments, the device can achieve interaction of distinct data layers through a method comprising: a) providing a physical layer interaction system, wherein the physical layer interaction system comprises: a control module, a retrieval module; and a transmittal module; b) controlling by the control module the interaction of a first physical layer, a second physical layer, a third physical layer, etc., wherein the controlling summarizes at least one computer-executable data package command, thereby providing a congruent interaction between the immediate physical layer and the next physical layer in the chain; c) retrieving by the retrieval module data from multiple physical layers; and d) transmitting by the transmitting module the retrieved data over a network.

In some embodiments, a system of the invention captures information from a medical device that supports an infrared communication protocol, using a intermediary serial to infrared hub, that is connected to another intermediary Bluetooth to serial hub, that is connected to mobile computing device via Bluetooth communication protocol, and/or using the mobile OS to communicate the data to an application running on a mobile device through a local API, and/or then using the mobile computing device cellular data connection to communicate the information obtained from the device to an application running on a server through a WEB API, to a Health Record System such as Microsoft® HealthVault™ through a REST API over TCP/IP network, or to a medical information management system such as Epic through a Web Services call over TCP/IP network.

In some embodiments of the invention, zero, one, or more than one devices are integrated on the individual communication layer available through these methods. Non-limiting examples would be capturing information from one or multiple medical devices connected directly via Bluetooth, as well as from one or multiple infrared or ANT+ devices connected via serial to infrared or ANT+ hub to the USB port via the USB to serial hub, as well as from one of multiple serial devices connected to the USB port via USB to serial hub or connected to Bluetooth via Bluetooth to serial adapter.

A system of the invention can provide a mobile software application interface providing a human-computer layer control and a dashboard for the data exchange between medical health devices, such as medical meters, and mobile computing devices. In some embodiments, the device is provided in a form of a mobile software development kit (SDK) package with an application programming interface (API). In some embodiments, a SDK package can provide connectivity to at least a medical meter and an electronic device.

A software development kit (SDK) of the invention can comprise a set on instructions for providing connectivity to a medical meter. A software development kit (SDK) of the invention can comprise an application programmable interface (API), providing defined inputs and outputs.

Transmission of Data from Non-Congruent Sources.

A system of the invention can provide a physical layer interaction system. A medical meter can comprise a first physical layer which interacts with a second physical layer. A physical layer interaction system can retrieve and add a plurality of computer executable commands retrieved from a medical meter. A physical layer interaction system can process, add, and summarize a totality or a summary of a plurality of computer executable commands retrieved from a physical layer in a medical meter. A physical layer interaction system can transmit the data to an electronic device that is not congruent with a medical meter. In some embodiments, the physical layer interaction system retrieves a plurality of computer executable commands from a medical device that are specified in a computer executable language that is not compatible with the computer executable language of the mobile computing device. In some embodiments, the physical layer interaction system summarizes a data content of a computer executable command retrieved from a medical meter in order to transmit the data content to an electronic computing device that is otherwise not compatible with the medical meter. In some embodiments, the process of summarizing data retrieved from a medical meter provides a method for harmonizing the congruency and compatibility of otherwise incongruent medical meters and electronic devices. In some embodiments, a system can comprise multiple consecutive non-congruent physical layers, which can connect to zero, one, or multiple components independently at each layer. In some embodiments, the system encapsulates and/or strips out additional frames to control non-congruent hubs to be able to transmit the relevant data across multiple physical layers.

### Reporting.

Upon receiving data from a medical meter, a system of the invention can prepare a report either automatically or at the instruction of a user. A report can be communicated to a user over a network, for example, a secure network, an insecure network, a local network, a global network, a proprietary network, an intranet, or an internet. A report can contain any output information useful to the user. Non-limiting examples of output information include input information, results, time frame, start time, end time, serial number, user name, and IP address.

In some embodiments, a report comprising data retrieved from a medical meter can inform a health care decision. For example, a report can comprise data indicating high blood glucose levels. A health care provider can, for example, prescribe a medication for the high blood glucose level based in the report comprising data from the medical meter. A report can be transmitted to a subject, to a health care provider, to a hospital, to a care center, to a remote monitoring facility, to friends, and to family. A subject can manually forward a report to a user of the system. A system of the invention can automatically forward a report to authorized users on behalf of a subject.

A medical meter can, for example, provide a medical report that allows a health care provider to monitor a subject remotely. In some embodiments, a system of the invention provides a method of monitoring a subject remotely, the method comprising retrieving data from a medical meter and transmitting the data to a health care provider. Remote monitoring can, for example, allow a health care provider to monitor a subject in a subject's environment.

Non-limiting examples of the environment include the subject's home, a nursing home, a hospital, an out-patient center, a care center, an assisted living facility, a correction facility, and/or a rehabilitation center.

A report can be tailored to a specific disease or condition. For example, a cardiologist remotely monitoring physiological cardiac parameters of a subject can, for example, receive data retrieved from medical meters measuring electrocardiogram (ECG), heart rate, respiratory rate, activity level, weight, and blood pressure in a report that is specific to heart disease. The report can, for example, indicate a desirable threshold for the retrieved data for the specific patient. A physical therapist monitoring the foregoing data can receive a report that is primarily focused on how the retrieved data relates to a physical therapy goal of, for example, remediating an impairment or a disability. In some embodiments, transmitting a report creates a medical record data point.

In some embodiments, a system of the invention provides a method of recording data, the method comprising: a) providing communication between a computer system and a medical meter, wherein the computer system comprises a processor; b) retrieving, by the processor, data from the medical meter; and c) recording the retrieved data on an electronic medical record associated with a subject.

In some embodiments, a report comprises personalized health data from a subject. In some embodiments, a report transmits personalized health data from a subject to a health care provider, and the health care provider records the retrieved data in a medical record. In some embodiments, the report transmits medical meter data to an electronic medical record.

Electronic Medical Records (EMRs) can relate to records obtained and stored by a subject's doctor, clinician, insurance company, hospital and/or other facilities where a subject is a patient. Electronic Medical Records (EMRs) can relate to records obtained, stored and transmitted from a medical meter to a health care facility or provider. In some embodiments, the health care provider is at a remote monitoring center that provides a subject with remote health care monitoring and/or assistance. In some embodiments, a health care provider can include a medical doctor, a nurse, a physical therapist, a dentist, a therapist, a chiropractor, and anyone who provides healthcare services to the subject. Electronic medical records (EMR) can comprise, for example, CAT scans, MRIs, ultrasounds, blood glucose levels, diagnoses, allergies, lab test results, EKGs, medications, daily charting, medication administration, physical assessments, admission nursing notes, nursing care plans, referrals, present and past symptoms, medical history, life style, physical examination results, tests, procedures, treatments, medications, discharges, history, diaries, problems, findings, immunizations, admission notes, on-service notes, progress notes, preoperative notes, operative notes, postoperative notes, procedure notes, delivery notes, postpartum notes, and discharge notes.

In some embodiments, data transmission/delivery from a medical meter is compliant with HIPAA standards. In some embodiments, data transmission/delivery is not compliant with HIPAA standards.

### Example 1

### Medical Device Network for Patient Monitoring Devices

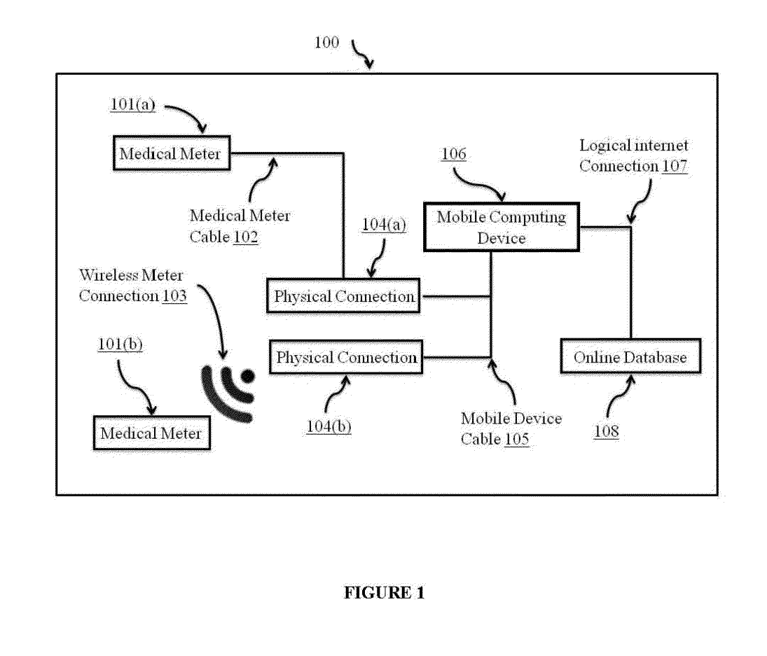

FIG. 1 is a block diagram illustrating a first example architecture of mobile computing device, mobile medical device, and network system 100 that can be used in connection with example embodiments of the present invention. As depicted in FIG. 1, the example network system can include a mobile computing device 106 to operate the system. Non-limiting examples of mobile computing devices include: Samsung Galaxy Nexus™, Motorola XOOM 10.1 inch and 7.1 inch Tablet™, iPhone 4/4S/5™, iPad 2™, Nokia Windows Mobile Phone 7 or 8™, or a functionally-equivalent mobile computing device. In some embodiments, multiple mobile computing devices can be used, whether with a single or multiple medical monitors, either directly connected or integrated (networked) via a system of converter hubs or communication devices.

As illustrated in FIG. 1, an online database 108 can be connected by a logical internet connection 107 to the mobile computing device 106 to provide backup and retrieval of data from a remote online storage facility for accessibility and to protect from loss or corruption on the mobile computing device 106. The mobile computing device 106 is connected to a physical connection 104(a) by a mobile device cable 105. Mobile device cable 105 can be, for example, USB cable, serial cable, audio cable, another standard cable, a combination of the foregoing, or a custom cable, for example, Apple iPhone™, iPad™, or iPod™ 30 pin adapter or 7 pin adapter. The physical connection 104(a) is connected to a medical meter 101(a) by a medical meter cable or medical meter data read cable 102. The connection can function as the conversion, the integration, or the networking interface for mobile computing device 106. Medical meter cable 102 can be, for example, OneTouch Ultra USB or Serial Cable™, Bayer USB or Serial Data Cable™, Freestyle Data Cable with USB or Serial™, or another standard (OEM) and medical device communication peripheral or cable, or a custom third party-built medical device compatible peripheral or cable, or a cable composed of off-the-shelf components. In some architectures, the physical connection 104(b) is connected to a wireless medical meter 101(b) by a wireless meter connection 103. The physical connection functions as the wireless hub, conversion, integration, or networking interface for mobile computing device 106. The wireless meter connection, can be, for example, CDMA, GSM, ZigBee, WiFi, Bluetooth, Infrared, NFC, or another standard or custom wireless communication protocol. In some alternative architectures, the functionality of the physical connection 104(a) and/or 104(b) can be incorporated into the processor instead of using a separate physical electrical component.

In some embodiments, mobile computing device 106 can operate a network system with one or several physical connections 104(a)/(b) simultaneously connected to the medical meters 101(a)/(b).

In some embodiments, logical internet connection 107, which provides connectivity for a mobile device to the Internet, can be, for example, cable-based or wireless either direct or conducted via an intermediary device. Non-limiting examples of cable-based connections include: USB cable, serial cable, audio cable, a combination of the foregoing, or a custom cable, for example, Apple iPhone™, iPad™, and iPod™ 30 pin adapter or 7 pin adapter. Non-limiting examples of wireless connections include: WiFi, Bluetooth, Infrared, NFC, and other standard wireless communication protocols. The connectivity option can be optimized for compatibility with the mobile computing device 106 hardware and/or operating software platform. The mobile computing device can abstract the networking layers associated with internet connectivity in standard ways providing acessibility to the user and software applications.

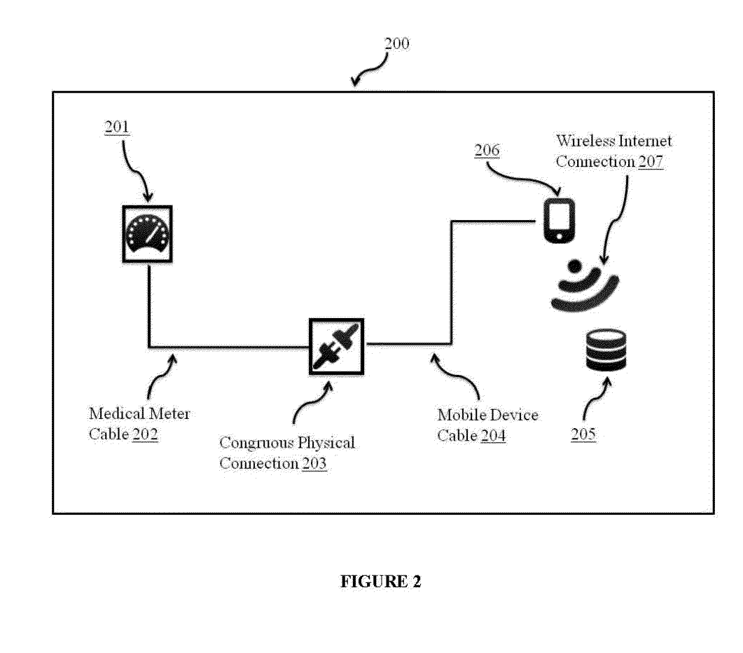

FIG. 2 is a diagram illustrating a mobile computer and medical device network 200 configuration with congruous physical connection 203, medical meter device 201, mobile computing device 204, and online database 203. In example embodiments, medical meter 201 is connected by a medical meter cable 205 to the congruous physical connection 202, which in turn is connected by mobile device cable 206 to the mobile computing device 204. Mobile computing device 204 connects and operates the medical meter 201 via congruous physical interface 202 by sending data in a compatible or congruous method or networking protocol across mobile meter cable 205 and mobile device cable 206. Mobile computing device 204 is connected by a wireless internet connection 207 to the online database 203 for medical meter data backup.

FIG. 2 illustrates an example only, and a wide variety of other computer architectures and systems can be used in conjunction with the various embodiments of the present invention. For example, the mobile computing device 206 can operate multiple medical meters at the same time or connect using different networking configurations and protocols. The number of simultaneous congruous physical connections, the type of networking configurations, and, thus, the number medical meters that mobile computing devices 206 can successfully operate can depend on the type of medical meter cable 202, the properties of congruous physical connection 203, and the capabilities of the mobile device hardware and/or operating software platform.

In some embodiments, the congruous physical connection 203 can be a simple and standard physical layer networking interface between two cables with compatible congruous physical electrical properties. The congruous physical connection can involve one male and one female physical end plug. In cases wherein both devices and cables have the same male-male or female-female end plug, a passive connector cable that is either female-female or male-male is connected, respectively.

In some architectures of the invention, in order to increase functionality, to reduce auxiliary components, to improve efficiency, and/or to reduce the total costs of operation, the medical meter 201 and/or the mobile computing device 206, can contain, integrate, or have built-in versions of the congruous physical connection 203. Such a modification provides equivalent functionality.

In some embodiments, when medical meter cable 202 and mobile device cable 204 are connected by a congruous physical connection 203 they have physically congruent and/or electrically-compatible properties. This creates compatible serial communication protocol types. The mobile device is thus directly communicating with the medical meter. This direct communication occurs without additional conversion and interpretation. Non-limiting examples of serial protocols include USB, TTL, and RS-232.

In some embodiments, some or all of the mobile computing devices and medical meters in the system are not physically congruent, not electrically compatible, and/or do not use the same communication protocol, yet can be connected via intermediary hubs and/or communicate wirelessly.

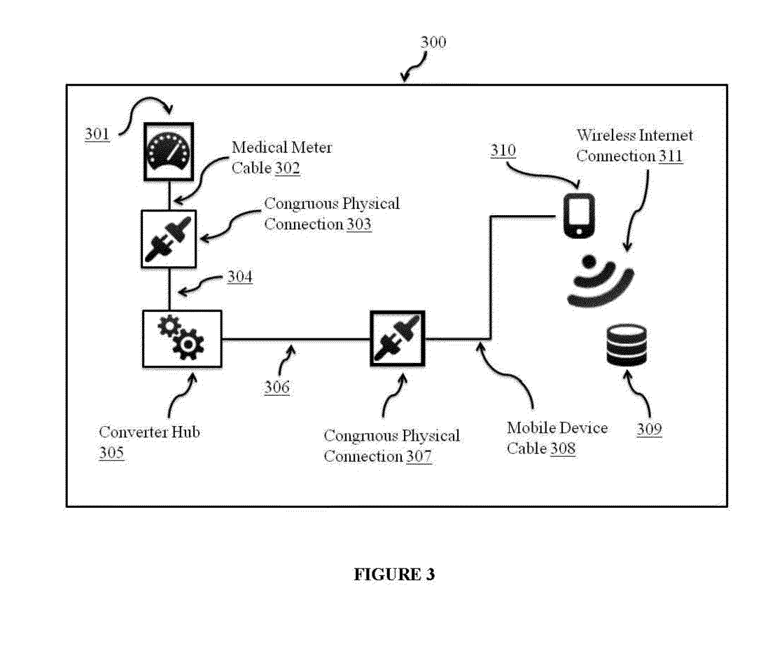

FIG. 3 is a diagram illustrating a mobile computer and medical device network 300 configuration with congruous physical connections 303 and 307, a converter hub 305, a medical meter device 301, a mobile computing device 310, and an online database 309. In example embodiments, medical meter 301 is connected by a medical meter cable 302 to the congruous physical connection 303, which in turn is connected by converter hub cable 304 to the converter hub 305. The mobile computing device is connected by mobile device cable 308 to the congruous physical connection 307, which in turn is connected by converter hub cable 306 to the converter hub 305. Mobile computing device 310 is connected by a wireless internet connection 311 to the online database 309 for medical meter data backup.

FIG. 3 illustrates an example only, and a wide variety of other computer architectures and systems can be used in conjunction with the various embodiments of the present invention. For example, the mobile computing device 310 can operate multiple medical meters at the same time or connect using similar or different networking configurations. The number of simultaneous congruous physical connections, the type of networking configurations, and, thus, the number of medical meters that the mobile computing device 310 can successfully operate depends on the type of congruous physical connection 304, type of converter hub 305, and capabilities of the mobile device hardware and/or operating software platform. The implementation of these systems for communication to work with the mobile device improves the flow and accessibility of information.

In some embodiments, congruous physical connections 303 and 307 are not congruent to each other, nor are converter hub cables 304 and 306. Thus, medical meter cable 302 and mobile device cable 308 are also not congruent in physical and/or electrical properties, so that medical meter 301 and mobile computing device 310 cannot communicate directly. The converter hub 305 is a standard device that converts physical, electrical, and/or other communication protocol properties of the medical meter 301 to match those of mobile computing device 310. Non-limiting examples of converter hubs include USB to Serial converters, TTL to RS232 converters, and pulse modulators.

In some embodiments, the mobile computing device 310 connects and operates the medical meter 301 through congruous physical connection 303 via converter hub 305 by sending data (in and out) across congruous physical connection 307. Depending on the type of the conversion required, the converter hub can be a passive, non-logic operating, or active, logic operating device. In the case of passive device, the converter hub alters the physical or electrical properties of the connection, for example in pulse modulation or conversion of TTL to RS232 serial. In the case of active device, the converter hub can alter the physical and or electrical properties and logical communication protocol to allow communication between mobile device 310 and medical meter 301, for example, converting USB to serial.

In some embodiments, when converter hub 305 is of the active type (connections 307 and 303 are not congruent), the mobile computing device 310 uses a converter hub to convert its communication protocol to match that of the medical meter 301. Mobile computing device 310 first establishes connection, for example, via series of commands or handshakes, with the active converter hub 305. Then the mobile computing device 310 sets the communication parameters for the converter hub 305 to communicate with the medical meter 301. Non-limiting examples of standard connection parameters include: baud rate, data bits, stop bits, parity, flow control, and com port. The mobile device 310 then commands the converter hub to send data to and/or receive data from the medical meter.

In some embodiments, the mobile computing device 310, the converter hub 305, and the medical meter 301 form a network system with disparate communication parameters. To operate such a system, the mobile computing device can act as the server. Acting as the server, the mobile computing device creates a virtual networking model to work with the components of the system. The mobile computing device 310 sends command frames to the converter hub 305, and in the data section of the frame encapsulates the command frames for a medical meter 301. The converter hub automatically strips the relevant frame layer, then sends the rest of the data to the medical meter. Similarly, the converter hub automatically adds the relevant frame information, then sends the data from the medical meter inside the data portion of the frame.

In some embodiments, the mobile computing device 310 and the medical meter 301 are connected via a series of converter hubs 305 to form a network system with disparate communication parameters. To operate such a system, the mobile computing device acts as the server and creates a virtual networking model to work with the components of the system. The mobile computing device encapsulates the frame, using methods described herein, several times to deliver the messages across the disparate system with a series of several converter hubs.

In some architectures of the invention, in order to increase functionality, to reduce auxiliary components, to improve efficiency and/or to reduce the total costs of operation, the medical meter 301 and or the mobile computing device 310 can contain, integrate, or have built-in versions of converter hub 305. In some embodiments, the built-in or combined versions of the components can still be accessed in similar manner as external configuration. In some embodiments, the built-in versions of the components are no longer accessible and the mobile computing device communicates with the converter connected to the congruous physical connection, which is connected to the mobile device via mobile device cable.

In some embodiments, multiple medical meters exist in the same networked system, some with connections that are compatible and congruent to the mobile computing device, and some with connections that are not compatible or congruent via several intermediary hubs and/or communicating wirelessly. The mobile computing device 310 uses the virtual networking model to operate several devices at the same time.

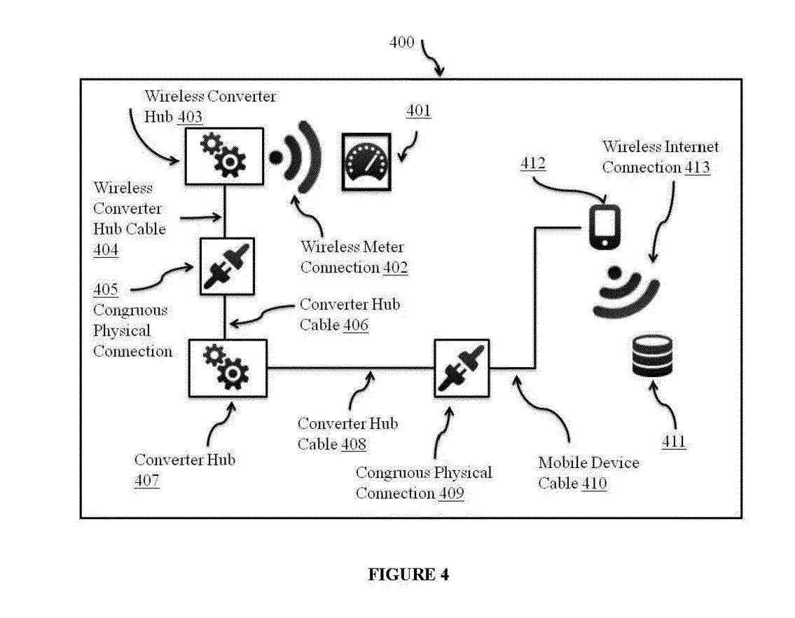

FIG. 4 is a diagram illustrating a mobile computer and medical device network 400 configuration with congruous physical connections 405 and 409, a converter hub 407, a wireless converter hub 403, a wireless medical meter device 401, a mobile computing device 412, and an online database 411. In example embodiments, wireless medical meter 401 is connected by a wireless meter connection 402 to the wireless converter hub 403. Wireless converter hub 403 is connected to the congruous physical connection 405 by a wireless converter hub cable 404, which in turn is connected by the converter hub cable 406 to the converter hub 407. The mobile computing device 412 is connected by mobile device cable 410 to the congruous physical connection 409, which in turn is connected by converter hub cable 408 to the converter hub 407. Mobile computing device 412 is connected by a wireless internet connection 413 to the online database 411 for medical meter data backup.

FIG. 4 illustrates an example only, and a wide variety of other computer architectures and systems can be used in conjunction with the various embodiments of the present invention. For example, the mobile computing device 412 can operate multiple wireless medical meters at the same time and/or connect using similar and/or different networking configurations. The number of simultaneous congruous physical connections, wireless meter connections, converter hub connections, the type of networking configurations, and, thus, the number medical meters a mobile computing device 412 can successfully operate can vary by the type of congruous physical connections 405 and 409, type of converter hub 407, type of wireless converter hub 403, and capabilities of the mobile device hardware and or operating software platform.

In FIG. 4, congruous physical connections 405 and 409 are not congruent to each other, nor are converter hub cables 406 and 408. Thus, wireless converter hub cable 404 and mobile device cable 410 are also not congruent in physical and or electrical properties, and the wireless converter hub 403 and the mobile computing device 412 cannot communicate directly. The converter hub 407 is a standard device that converts physical, electrical, and/or other communication protocol properties of the wireless converter hub 403 and cable 404 to match those of the mobile computing device 412 and mobile device cable 410. Non-limiting examples of converter hubs include USB to Serial converters, TTL to RS232 converters, and pulse modulators. The wireless converter hub 403 is a standard device that converts physical, electrical, and/or other communication protocol properties of the converter hub 405 and converter hub cable 408 to match those of the wireless medical meter 401. Non-limiting examples of wireless meter connection 402 include WiFi, ANT+, ZigBee Bluetooth, Infrared, NFC, and other standard wireless communication protocols, such as a custom protocol.

In some example embodiments, mobile computing device 412 connects and operates the wireless converter hub 403 through congruous physical connection 405, to connect to medical meter 401 through wireless meter connection 402, via converter hub 405 by sending data across congruous physical connection 409. Depending on the type of the conversion required, the converter hub 407 can be a passive, non-logic operating, or an active, logic operating device. In the case of a passive device, the converter hub alters the physical or electrical properties of the connection, for example, in pulse modulation or conversion of TTL to RS232. In the case of an active device, the converter hub alters the physical properties, electrical properties, and logical communication protocol to allow communication between mobile device 412 and wireless converter hub 403, for example, converting USB to serial. Depending on the type of conversion required, the wireless converter hub 403 is an active, logic operating device that converts physical properties, electrical properties, and logical communication protocols to allow wireless communication with converter hub 407 by connecting mobile computing device 412 and wireless medical meter 401.

In some example embodiments, when converter hub 407 is of the active type (connections 405 and 409 are not congruent) the mobile computing device 412 uses the converter hub to convert its communication protocol to match that of the wireless converter hub cable 404 to connect to wireless converter hub 403 to convert its communication protocol further to match that of the wireless meter connection 402 to integrate with medical meter 401. Mobile computing device 412 first has to establish connection, for example, via a series of commands or handshakes, with the active converter hub 407. The communication parameters can be set for the converter hub 407 to communicate with the wireless converter hub 403 via wireless converter hub cable 404. Then mobile computing device 412, using converter hub 407, establishes a connection, for example, via series of commands or handshakes, with the wireless converter hub 403. The wireless communication parameters for the wireless converter hub 403 can be set to communicate with the wireless medical meter 401 via the wireless meter connection 402. Non-limiting examples of standard connection parameters include: baud rate, data bits, stop bits, parity, flow control, and communication port. The mobile computing device commands the converter hub to send data to and/or receive data from the wireless converter hub, which, in turn, sends and/or receives data to/from the wireless medical meter.

In some embodiments, the mobile computing device 412, the converter hub 407, the wireless converter hub 403, and the medical meter 401 form a network system with disparate communication parameters. In order to operate such a system, the mobile computing device acts as the server and creates a virtual networking model to work with the components of the system. The mobile computing device 412 sends commands to the converter hub 407 and includes the commands for a wireless converter hub 403 and for medical meter 401 in the data section of the messages or frames sent to the converter hub. The converter hub automatically strips the relevant frame layer, then sends the rest of the data to the wireless converter hub, which, in turn, automatically strips the relevant frame layer, then sends the rest of the data to the wireless medical meter. Similarly, the converter hub and the wireless converter hub automatically add the relevant frame information, then send the data from the medical meter inside the data portion of the frame.

In some architectures of the invention, in order to increase functionality, to reduce auxiliary components, to improve efficiency, and/or to reduce the total costs of operation, the medical meter 401 and or the mobile computing device 412 can contain, integrate, or have built-in versions of wireless converter hub 403 and/or converter hub 407. Likewise, wireless converter hub 403 and converter hub 407 can be combined or integrated to function as one device. In some embodiments, the built-in or combined versions of the components can still be accessed in a similar manner as an external configuration. In some embodiments, the built-in versions of the components are no longer accessible and the mobile computing device communicates with the converter connected to the congruous physical connection, which is connected to the mobile device via mobile device cable.

### Example 2

### Computer Architectures

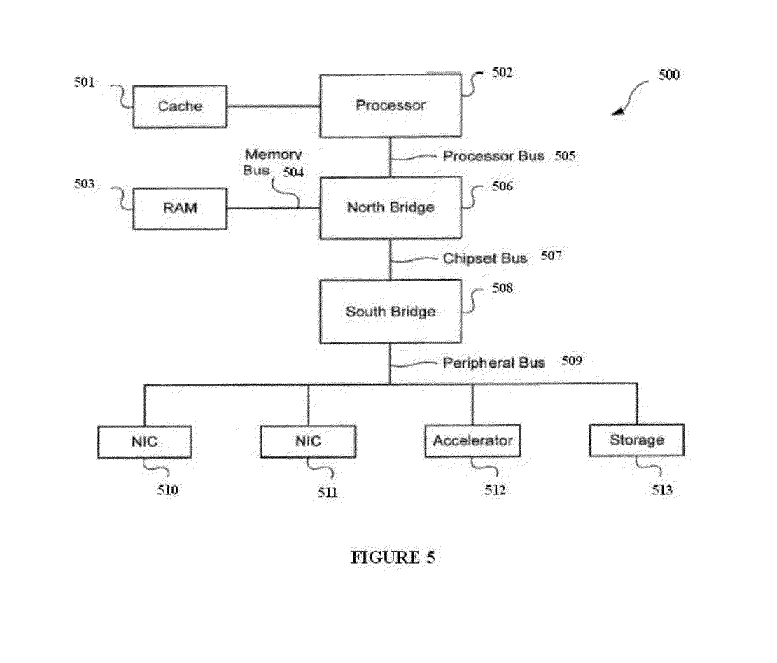

Various computer architectures are suitable for use with the invention. FIG. 5 is a block diagram illustrating a first example architecture of a computer system 500 that can be used in connection with example embodiments of the present invention. As depicted in FIG. 5, the example computer system can include a processor 502 for processing instructions. Non-limiting examples of processors include: Intel Core i7™ processor, Intel Core i5™ processor, Intel Core i3™ processor, Intel Xeon™ processor, AMD Opteron™ processor, Samsung 32-bit RISC ARM 1176JZ(F)-S v1.0™ processor, ARM Cortex-A8 Samsung S5PC100™ processor, ARM Cortex-A8 Apple A4™ processor, Marvell PXA 930™ processor, or a functionally-equivalent processor. Multiple threads of execution can be used for parallel processing. In some embodiments, multiple processors or processors with multiple cores can be used, whether in a single computer system, in a cluster, or distributed across systems over a network comprising a plurality of computers, cell phones, and/or personal data assistant devices.

### Data Acquisition, Processing and Storage.

As illustrated in FIG. 5, a high speed cache 501 can be connected to, or incorporated in, the processor 502 to provide a high speed memory for instructions or data that have been recently, or are frequently, used by processor 502. The processor 502 is connected to a north bridge 506 by a processor bus 505. The north bridge 506 is connected to random access memory (RAM) 503 by a memory bus 504 and manages access to the RAM 503 by the processor 502. The north bridge 506 is also connected to a south bridge 508 by a chipset bus 507. The south bridge 508 is, in turn, connected to a peripheral bus 509. The peripheral bus can be, for example, PCI, PCI-X, PCI Express, or other peripheral bus. The north bridge and south bridge are often referred to as a processor chipset and manage data transfer between the processor, RAM, and peripheral components on the peripheral bus 509. In some architectures, the functionality of the north bridge can be incorporated into the processor instead of using a separate north bridge chip.

In some embodiments, system 500 can include an accelerator card 512 attached to the peripheral bus 509. The accelerator can include field programmable gate arrays (FPGAs) or other hardware for accelerating certain processing.

### Software Interfaces.

Software and data are stored in external storage 513 and can be loaded into RAM 503 and/or cache 501 for use by the processor. The system 500 includes an operating system for managing system resources; non-limiting examples of operating systems include: Linux, Windows™, MACOS™, BlackBerry OS™, iOS™, and other functionally-equivalent operating systems, as well as application software running on top of the operating system.

In this example, system 500 also includes network interface cards (NICs) 510 and 511 connected to the peripheral bus for providing network interfaces to external storage, such as Network Attached Storage (NAS) and other computer systems that can be used for distributed parallel processing.

### Computer Systems.

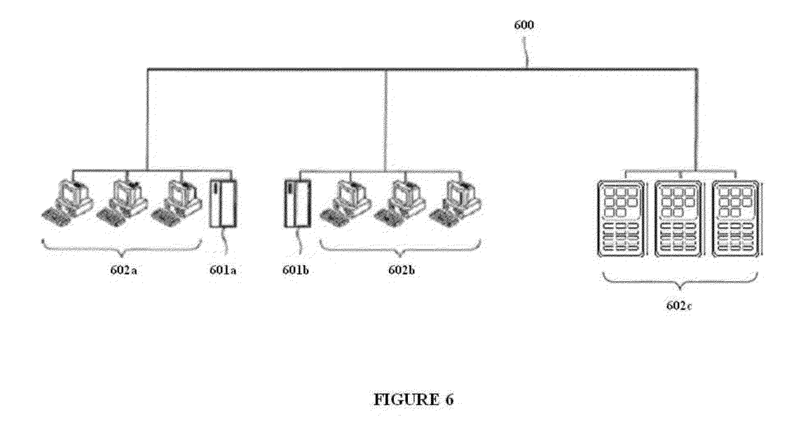

FIG. 6 is a diagram showing a network 600 with a plurality of computer systems 602a, and 602b, a plurality of cell phones and personal data assistants 602c, and Network Attached Storage (NAS) 601a, and 601b. In some embodiments, systems 602a, 602b, and 602c can manage data storage and optimize data access for data stored in Network Attached Storage (NAS) 601a and 602b. A mathematical model can be used for the data and be evaluated using distributed parallel processing across computer systems 602a, and 602b, and cell phone and personal data assistant systems 602c. Computer systems 602a, and 602b, and cell phone and personal data assistant systems 602c can also provide parallel processing for adaptive data restructuring of the data stored in Network Attached Storage (NAS) 601a and 601b.

FIG. 6 illustrates an example only, and a wide variety of other computer architectures and systems can be used in conjunction with the various embodiments of the present invention. For example, a blade server can be used to provide parallel processing. Processor blades can be connected through a back plane to provide parallel processing. Storage can also be connected to the back plane or as Network Attached Storage (NAS) through a separate network interface.

In some embodiments, processors can maintain separate memory spaces and transmit data through network interfaces, back plane, or other connectors for parallel processing by other processors. In some embodiments, some or all of the processors can use a shared virtual address memory space.

### Virtual Systems.

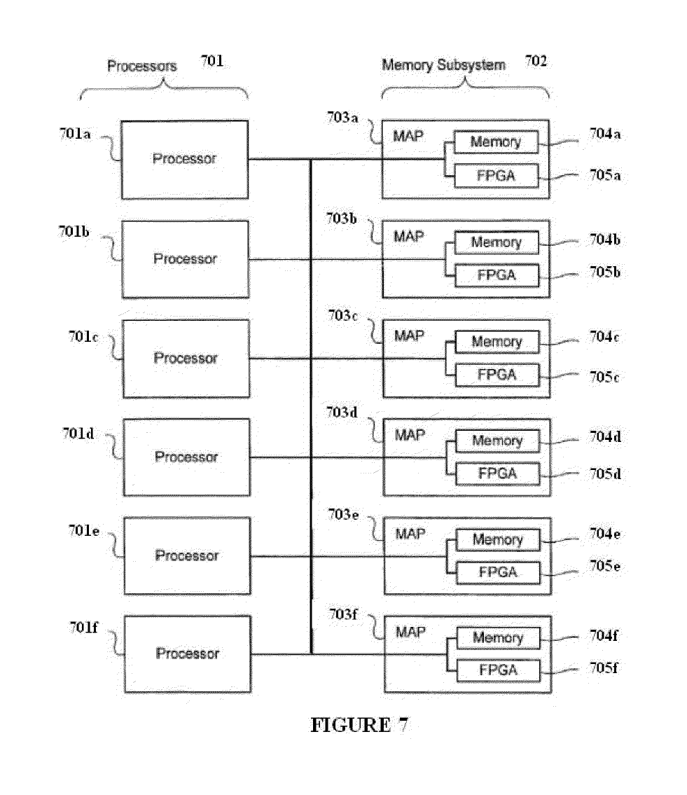

FIG. 7 is a block diagram of a multiprocessor computer system using a shared virtual address memory space. The system includes a plurality of processors 701a-f that can access a shared memory subsystem 702. The system incorporates a plurality of programmable hardware memory algorithm processors (MAPs) 703a-f in the memory subsystem 702. Each MAP 703a-f can comprise a memory 704a-f and one or more field programmable gate arrays (FPGAs) 705a-f. The MAP provides a configurable functional unit and particular algorithms or portions of algorithms can be provided to the FPGAs 705a-f for processing in close coordination with a respective processor. In this example, each MAP is globally accessible by all of the processors for these purposes. In one configuration, each MAP can use Direct Memory Access (DMA) to access an associated memory 704a-f, allowing it to execute tasks independently of, and asynchronously from, the respective microprocessor 701a-f. In this configuration, a MAP can feed results directly to another MAP for pipelining and parallel execution of algorithms.

The above computer architectures and systems are examples only, and a wide variety of other computer, cell phone, and personal data assistant architectures and systems can be used in connection with example embodiments, including systems using any combination of general processors, co-processors, FPGAs and other programmable logic devices, system on chips (SOCs), application specific integrated circuits (ASICs), and other processing and logic elements. Any variety of data storage media can be used in connection with example embodiments, including random access memory, hard drives, flash memory, tape drives, disk arrays, Network Attached Storage (NAS) and other local or distributed data storage devices and systems.

In some embodiments, the computer system can be implemented using software modules executing on any of the above or other computer architectures and systems. In other embodiments, the functions of the system can be implemented partially or completely in firmware, programmable logic devices such as field programmable gate arrays (FPGAs) as referenced in FIG. 7, system on chips (SOCs), application specific integrated circuits (ASICs), or other processing and logic elements. For example, the Set Processor and Optimizer can be implemented with hardware acceleration through the use of a hardware accelerator card, such as accelerator card 512 illustrated in FIG. 5.

In some embodiments, the invention described herein comprises a computer program product adapted to provide a connectivity system to a plurality of medical meters. A product of the invention can be a data record provided by the connectivity system. The data record can, for example, be retrieved from a medical meter. A data record can be, for example, produced in one geographic location and transmitted to the same geographic location. A data record can be, for example, produced in one geographic location and transmitted to a different geographic location. A medical meter can, for example, be utilized by a subject that is physically present in one country and the recorded data within the medical meter can be retrieved by a user that is physically present in a different country.

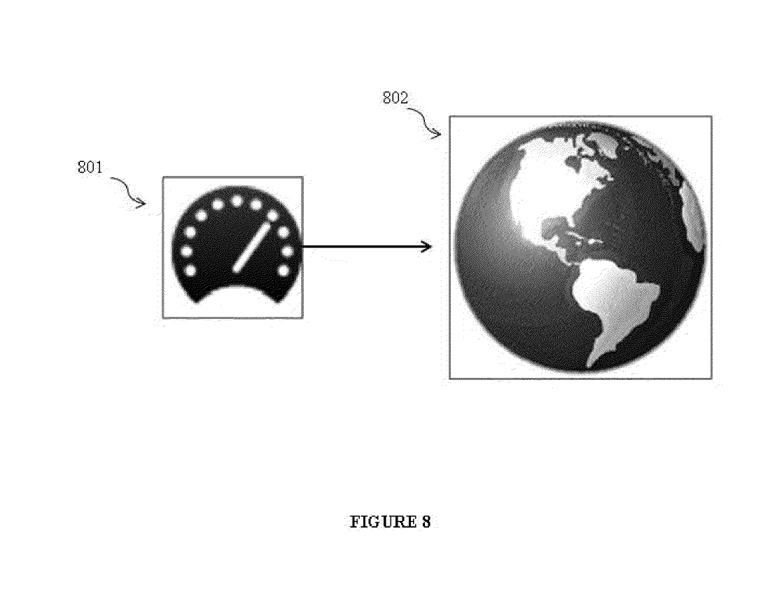

In some embodiments, the product of the invention is the computer program data product comprising a connectivity system that can be accessed and navigated by a user. In some embodiments, the computer program product of the invention comprises data that can be transmitted from one of a plurality of geographic locations 801 to a user in one of a plurality of geographic locations 802 (FIG. 8). Data from a connectivity system of the invention can be transmitted back and forth among a plurality of geographic locations, for example, by a network, a secure network, an insecure network, an internet, or an intranet. In some embodiments, the recorded data is a physical and tangible product. In some embodiments, the recorded data comprises a data point in a medical record.

### EMBODIMENTS

The following non-limiting embodiments provide illustrative examples of the invention, but do not limit the scope of the invention.

### Embodiment 1

A method of recording data, the method comprising: a) providing communication between a computer system and a medical meter, wherein the computer system comprises a processor; b) retrieving, by the processor, data from the medical meter; and c) recording the retrieved data on an electronic medical record associated with a subject.

### Embodiment 2

The method of embodiment 1, wherein the medical meter monitors the subject.

### Embodiment 3

The method of embodiment 2, wherein the subject is monitored remotely.

### Embodiment 4

The method of embodiment 2, wherein the subject wears the medical meter.

### Embodiment 5

The method of any one of embodiments 1-4, wherein the medical meter monitors an environment of the subject.

### Embodiment 6

The method of any one of embodiments 1-5, further comprising transmitting the retrieved data to a user.

### Embodiment 7

The method of any one of embodiments 1-6, wherein the retrieving of the data is wireless.

### Embodiment 8

The method of any one of embodiments 1-6, wherein the retrieving of the data is by a wired connection.

### Embodiment 9

The method of any one of embodiments 1-8, further comprising connecting the computer system to a plurality of medical meters, wherein each medical meter independently detects a different type of medical data.

### Embodiment 10

The method of embodiment 9, wherein the medical data from more than one of the medical meters is retrieved and recorded in the electronic medical record.

### Embodiment 11

The method of any one of embodiments 1-10, further comprising recommending a treatment for the subject based on the data.

### Embodiment 12

The method of embodiment 11, wherein the recommended treatment provides a diet recommendation.

### Embodiment 13

The method of embodiment 11, wherein the recommended treatment provides a lifestyle recommendation.

### Embodiment 14

A computer program product comprising a computer-readable medium having computer-executable code encoded therein, the computer-executable code adapted to be executed to implement a method for recording data, the method comprising: a) providing a connectivity system, wherein the connectivity system comprises: i) an integration module; ii) a retrieval module; and iii) a recording module; b) integrating by the integration module an application interface in an electronic device, wherein the application interface is compatible with a medical meter; c) retrieving by the retrieval module data from the medical meter via the application interface; and d) recording by the recording module the retrieved data in an electronic medical record.

### Embodiment 15

The computer program product of embodiment 14, wherein the integrating comprises installing an application on the electronic device.

### Embodiment 16

The computer program product of any one of embodiments 14-15, wherein the integrating comprises accessing an application on the electronic device.

### Embodiment 17

The computer program product of any one of embodiments 14-16, wherein the integrating comprises installing an application on the medical meter.

### Embodiment 18

The computer program product of any one of embodiments 14-17, wherein the integrating comprises accessing an application on the medical meter.

### Embodiment 19

The computer program product of any one of embodiments 14-18, wherein the connectivity system further comprises a reporting module, wherein the reporting module reports the retrieved data to a user.

### Embodiment 20

The computer program product of any one of embodiments 14-19, wherein the connectivity system further comprises a recommendation module, wherein the recommendation module provides a recommendation to a user based on the retrieved data.

### Embodiment 21

A method of recording data, the method comprising receiving, by a computer system, data from a medical meter, wherein the computer system comprises a processor, whereupon the processor records at least a portion of the received medical data in an electronic medical record.

### Embodiment 22

The method of embodiment 21, wherein the receiving of the data is wireless.

### Embodiment 23

The method of embodiment 21, wherein the receiving of the data is by a wired connection.

### Embodiment 24

The method of any one of embodiments 21-23, wherein the medical meter monitors a subject.

### Embodiment 25

The method of any one of embodiments 21-24, wherein the medical meter monitors an environment of a subject.

### Embodiment 26

The method of any one of embodiments 21-25, further comprising recommending a treatment for a subject based on the received medical data.

### Embodiment 27

The method of any one of embodiments 21-26, further comprising providing a treatment for a subject based on the received medical data.

### Embodiment 28

The method of any one of embodiments 21-27, further comprising receiving data from a plurality of medical meters, wherein each medical meter independently detects a different type of medical data.

### Embodiment 29

The method of embodiment 28, wherein the medical data from more than one of the medical meters is received and recorded in the electronic medical record.

### Embodiment 30

The method of any one of embodiments 21-29, further comprising selecting the electronic medical record from a plurality of sources of electronic medical records.

### Embodiment 31

The method of any one of embodiments 21-30, further comprising transmitting at least a portion of the received medical data to a third party record system.

### Embodiment 32

The method of any one of embodiments 21-31, further comprising transmitting different portions of the received medical data to different third party record systems.

### Embodiment 33

The method of any one of embodiments 21-32, further comprising transmitting at least a portion of the received medical data to a health care provider.

### Embodiment 34

A computer program product comprising a computer-readable medium having computer-executable code encoded therein, the computer-executable code adapted to be executed to implement a method supporting an interaction of distinct data layers, the method comprising: a) providing a physical layer interaction system, wherein the physical layer interaction system comprises: i) a control module; ii) a retrieval module; and iii) a transmittal module; b) controlling by the control module the interaction of a first physical layer and a second physical layer, wherein the controlling summarizes at least one computer-executable data package command, thereby providing a congruent interaction between the first physical layer and the second physical layer, wherein the first physical layer is associated with a medical meter; c) retrieving by the retrieval module data from the first physical layer; and d) transmitting by the transmitting module the retrieved data over a network.

### Embodiment 35

The computer program product of embodiment 34, wherein the data retrieved from the first physical layer is medical data.

### Embodiment 36

The computer program product of any one of embodiments 34-35, wherein the second physical layer is associated with an electronic device.

### Embodiment 37

The computer program product of any one of embodiments 34-36, wherein the retrieval module operates from a server remote from the medical meter.

### Embodiment 38

The computer program product of any one of embodiments 34-37, wherein the control module operates from a server remote from the medical meter.

### Embodiment 39

The computer program product of any one of embodiments 34-38, wherein the controlling by the control module is performed on a computer system comprising the second layer.

### Embodiment 40

The computer program product of any one of embodiments 34-39, wherein the physical layer interaction system further comprises a recording module, wherein the method further comprises recording by the recording module the retrieved data in an electronic medical record.

### Embodiment 41

The computer program product of any one of embodiments 34-40, wherein the method further comprises retrieving by the retrieval module data from an additional physical layer, wherein the additional physical layer is associated with an additional medical meter.

### Embodiment 42

The computer program product of any one of embodiments 34-41, wherein the physical layer interaction system further comprises an input module, wherein the input module is configured to accept input instructions associated with the transmitting.

What is claimed is:

1. A method of recording data, the method comprising:
a) providing communication between a computer system and a medical meter, wherein the computer system comprises a processor;
b) retrieving, by the processor, data from the medical meter; and
c) recording the retrieved data on an electronic medical record associated with a subject.

2. The method of claim 1, wherein the medical meter monitors the subject.

3. The method of claim 2, wherein the subject is monitored remotely.

4. The method of claim 2, wherein the subject wears the medical meter.

5. The method of claim 1, wherein the medical meter monitors an environment of the subject.

6. The method of claim 1, further comprising transmitting the retrieved data to a user.

7. The method of claim 1, wherein the retrieving of the data is wireless.

8. The method of claim 1, wherein the retrieving of the data is by a wired connection.

9. The method of claim 1, further comprising connecting the computer system to a plurality of medical meters, wherein each medical meter independently detects a different type of medical data.

10. The method of claim 9, wherein the medical data from more than one of the medical meters is retrieved and recorded in the electronic medical record.

11. The method of claim 1, further comprising recommending a treatment for the subject based on the data.

12. The method of claim 11, wherein the recommended treatment provides a diet recommendation.

13. The method of claim 11, wherein the recommended treatment provides a lifestyle recommendation.

14. A computer program product comprising a computer-readable medium having computer-executable code encoded therein, the computer-executable code adapted to be executed to implement a method for recording data, the method comprising:
a) providing a connectivity system, wherein the connectivity system comprises:
i) an integration module;
ii) a retrieval module; and
iii) a recording module;
b) integrating by the integration module an application interface in an electronic device, wherein the application interface is compatible with a medical meter;
c) retrieving by the retrieval module data from the medical meter via the application interface; and
d) recording by the recording module the retrieved data in an electronic medical record.

15. The computer program product of claim 14, wherein the integrating comprises installing an application on the electronic device.

16. The computer program product of claim 14, wherein the integrating comprises accessing an application on the electronic device.

17. The computer program product of claim 14, wherein the integrating comprises installing an application on the medical meter.

18. The computer program product of claim 14, wherein the integrating comprises accessing an application on the medical meter.

19. The computer program product of claim 14, wherein the connectivity system further comprises a reporting module, wherein the reporting module reports the retrieved data to a user.

20. The computer program product of claim 14, wherein the connectivity system further comprises a recommendation module, wherein the recommendation module provides a recommendation to a user based on the retrieved data.

21. A method of recording data, the method comprising receiving, by a computer system, data from a medical meter, wherein the computer system comprises a processor, whereupon the processor records at least a portion of the received medical data in an electronic medical record.

22. The method of claim 21, wherein the receiving of the data is wireless.

23. The method of claim 21, wherein the receiving of the data is by a wired connection.

24. The method of claim 21, wherein the medical meter monitors a subject.

25. The method of claim 21, wherein the medical meter monitors an environment of a subject.

26. The method of claim 21, further comprising recommending a treatment for a subject based on the received medical data.

27. The method of claim 21, further comprising providing a treatment for a subject based on the received medical data.

28. The method of claim 21, further comprising receiving data from a plurality of medical meters, wherein each medical meter independently detects a different type of medical data.

29. The method of claim 28, wherein the medical data from more than one of the medical meters is received and recorded in the electronic medical record.

30. The method of claim 21, further comprising selecting the electronic medical record from a plurality of sources of electronic medical records.

31. The method of claim 21, further comprising transmitting at least a portion of the received medical data to a third party record system.

32. The method of claim 21, further comprising transmitting different portions of the received medical data to different third party record systems.

33. The method of claim 21, further comprising transmitting at least a portion of the received medical data to a health care provider.

34. A computer program product comprising a computer-readable medium having computer-executable code encoded therein, the computer-executable code adapted to be executed to implement a method supporting an interaction of distinct data layers, the method comprising:
a) providing a physical layer interaction system, wherein the physical layer interaction system comprises:
i) a control module;
ii) a retrieval module; and
iii) a transmittal module;
b) controlling by the control module the interaction of a first physical layer and a second physical layer, wherein the controlling summarizes at least one computer-executable data package command, thereby providing a congruent interaction between the first physical layer and the second physical layer, wherein the first physical layer is associated with a medical meter;
c) retrieving by the retrieval module data from the first physical layer; and
d) transmitting by the transmitting module the retrieved data over a network.

35. The computer program product of claim 34, wherein the data retrieved from the first physical layer is medical data.

36. The computer program product of claim 34, wherein the second physical layer is associated with an electronic device.

37. The computer program product of claim 34, wherein the retrieval module operates from a server remote from the medical meter.

38. The computer program product of claim 34, wherein the control module operates from a server remote from the medical meter.

39. The computer program product of claim 34, wherein the controlling by the control module is performed on a computer system comprising the second layer.

40. The computer program product of claim 34, wherein the physical layer interaction system further comprises a recording module, wherein the method further comprises recording by the recording module the retrieved data in an electronic medical record.

41. The computer program product of claim 34, wherein the method further comprises retrieving by the retrieval module data from an additional physical layer, wherein the additional physical layer is associated with an additional medical meter.

42. The computer program product of claim 34, wherein the physical layer interaction system further comprises an input module, wherein the input module is configured to accept input instructions associated with the transmitting.
